(19) United States
(12) Patent Application Publication
(10) Pub. No.: US 2013/0041690 A1
(43) Pub. Date: Feb. 14, 2013

(54) HEALTH CARD REWARD SYSTEM

(71) Applicant: PAUL B. BROUGH, MARLBOROUGH, MA (US)

(72) Inventor: PAUL B. BROUGH, MARLBOROUGH, MA (US)

(21) Appl. No.: 13/567,816

(22) Filed: Aug. 6, 2012

Related U.S. Application Data
(60) Provisional application No. 61/523,389, filed on Aug. 14, 2011.

(51) Int. Cl. G06Q 30/02; G06Q 50/24; G06Q 50/22

(52) U.S. Cl. 705/3

(57) ABSTRACT

A system for the management of the interaction between the patient and health care providers and of the patient's medical records. The patient receives reward points for using the program that involves selecting health-care providers from a preferred list. The system employs a smartcard that securely identifies the patient, securely carries the patient's medical records in memory, and carries the records of the patient's reward points. Each healthcare provider has highly-secure equipment that allows the reading from and writing to the smartcard. The system is managed by a remote central computer system that operates over a global communication network.

### CROSS-REFERENCE TO RELATED APPLICATIONS

This application claims the benefit under 35 U.S.C. §119(e) of U.S. Provisional Application No. 61/523,389 filed Aug. 14, 2012, which is hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

This invention involves an system for managing the health care services.

### BACKGROUND OF THE INVENTION

Prior systems for managing and monitoring the decisions and delivery of health care services between patients and health care providers been characterized by inefficiency, a proneness to errors in communicating critical information among the parties, an inability to compartmentalize relevant information among various relevant parties, and difficulty in use.

These and other difficulties experienced with the prior art devices have been obviated in a novel manner by the present invention.

It is, therefore, an outstanding object of some embodiments of the present invention to provide a system for managing the selection and delivery of health care services in an efficient and effective manner.

Another object of some embodiments of the present invention is to provide a system for managing the managing the selection and delivery of health care services in a secure manner.

A further object of some embodiments of present invention is to provide a system for managing the selection and delivery of health care services that minimizes errors in communicating critical information among the parties.

It is another object of some embodiments of the present invention is to provide a system for managing the selection and delivery of health care services that has the ability to compartmentalize relevant information among various relevant parties.

It is a further object of some embodiments of the present invention to provide a system for managing the selection and delivery of health care services that is simple and easy to use by all relevant parties.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

A system for the management of the interaction between the patient and health care providers and of the patient's medical records. The patient receives reward points for using the system which promotes selecting health-care providers from a preferred list. The system employs a smartcard that securely identifies the patient, securely updates the patient's medical records in memory, and carries the records of the patient's reward points on a proprietary website. Each healthcare provider has highly-secure equipment that allows the reading from and writing to the smartcard. The system is managed by a remote central computer system that operates over a global communication network.

A system for managing the delivery of health care services. A patient is enrolled in the system and issued a smart-card which securely carries the patient's medical information. The patient selects an approved health care provider from an list of approved healthcare providers and presents the smart-card to the selected healthcare provider. The healthcare provider authenticates the smart-card and reads the data from it. The healthcare provider provides healthcare services and then updates the medical information on the smart-card. The system is informed of the transaction. The patient is rewarded for using the card and for using the program.

### BRIEF DESCRIPTION OF THE DRAWINGS

The character of the invention, however, may best be understood by reference to one of its structural forms, as illustrated by the accompanying drawing, in which:

FIG. 1 is shows a block diagram of the general features of one embodiment of the present invention.

FIG. 2 is shows a block diagram of the general features of repeatable aspects of one embodiment of the present invention.

FIG. 3 is shows a diagrammatic representation of the details of one embodiment of the present invention.

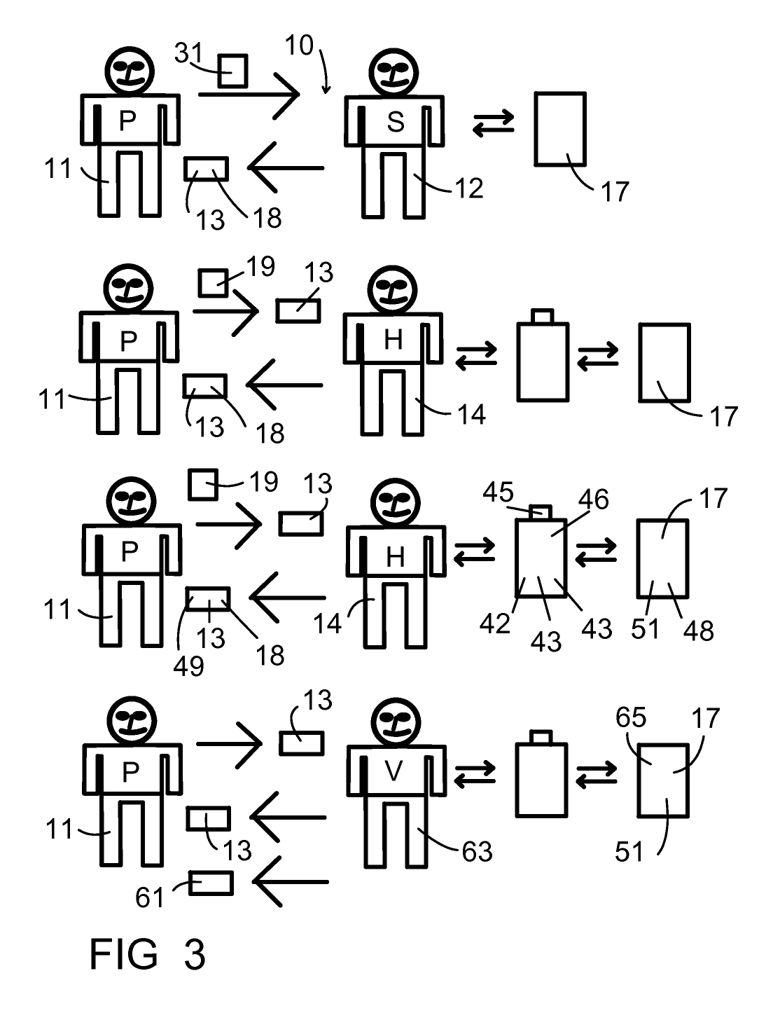

### DETAILED DESCRIPTION OF THE INVENTION

Health Care Rewards Program: This invention is a bold initiative to improve the quality and efficiency of medical care delivery and embrace patient empowerment. Healthcare is a complex and confusing maze to most patients, who must try to integrate finding a quality provider with the financial intricacies of the healthcare payment system. This invention is a healthcare smart-card program that is unique in the fact that it contains the patient's personal health record, while at the same time offering a point rewards program to encourage the use of high quality, cost effective providers. The goal of the program is to improve the quality of care by providing a consistent data record about the patient to all involved with the program.

This invention provides healthcare smart-cards free of charge to the public. Everyone is eligible, regardless whether they are insured or uninsured or whether they are healthy or not. The use of this technology encourages patient engagement in their own healthcare decisions, as well as encouraging interaction with their healthcare providers, thus making the patient a more educated consumer.

The data contained on the card is highly secure. A two card system, using two special readers, special software authentication, as well as a separate security verification through a proprietary website, allow for the information stored on the healthcare smart-card to be read by authorized providers. There is no patient name on the outside of the card, so if it were lost or stolen, no one finding it could distinguish it from a blank card (except an authorized provider).

The program fills the need created by an evolving healthcare landscape that has been driven in the past few years by high deductible plans from insurance companies, forcing patients to pay the first $2,000 or more of their healthcare services per year. This invention simplifies the complexity of the healthcare system by directing the patients to high quality, cost-effective providers that have joined the program.

The point reward portion of the program is used by the invention to spread adoption of the program by motivating people to take care of themselves. Other industries, such as the airline and hotel sectors, have created excitement with consumers by offering points for a number of years. In today's society, many industries use reward programs to encourage behaviors. This invention encourages people to take care of themselves and stay healthy.

This invention can be replicated in all parts of the country. This is bold innovation at its finest.

The Health Care Market—A Paradigm Shift Has Occurred Over The Past Ten Years In America—The HMOs Pushed The Market, and Now The Market Pushes Back. The industry known as healthcare is unlike any other that exists in this country. Most industries rely on market forces working through the efforts of supply and demand to create a competitive marketplace that, at least in theory, provides high value for reasonable cost. There are many examples of exceptions within industries, causing the pendulum to go “outside the lines” briefly, and then swing back to relative normalcy.

Healthcare defies that logic. When we examine why, we clearly see that financial accountability is a missing link. The insurance industry, originally used as a way to bring patients and providers together so more could access care, has become flawed. Historically, patients have not had to pay for healthcare in America directly. We all pay indirectly through an insurance program sponsored by our employer. As the years evolved, we expected to access the healthcare system as often as we liked, because we paid for insurance coverage, or so we thought. In actuality, the employers have picked up most of the insurance costs, but the out-of-control, no accountability system has caused everyone to reassess the landscape.

The New Reality—Employers can no longer afford to subsidize the healthcare system with continual double-digit increases. The bottom line impact has become so large to the employer community, that jobs are being lost and the economy is in a tailspin. Employers for years have tried to “cost-shift” the healthcare expense to employees by plan design changes, co-pay and deductible shifts, etc. These changes have been relatively minor compared to today's reality. Drastic measures are being taken by insurers and employers in shifting the burden to the consumer. Consumer-driven health plans have become the new standard for insurance coverage. These plans are geared toward catastrophic loss, while leaving the first $1,000 or $2,000 as a deductible for the patient to pay. Outlined below are tables showing the shift in recent years to high deductible consumer driven health plans.

A Quick Education—The relatively sudden shift to high deductible plans has caused the public to become quickly educated on how the healthcare system works. The education includes realities that not all services are delivered with high quality, and more importantly, that the cost of the same healthcare service can vary by 200% or more, depending on the service provider. This has been the industry's “dirty little secret” since insurance companies have hidden these facts by historically paying for most everything as a third party, except for a small co-pay.

However, accessing the healthcare system remains a daunting task. Many years ago, the family doctor, “Dr. Marcus Welby”, handled all the arrangements for providing care to an individual. The trust aspect was directly between the patient and their physician. The current healthcare landscape is far more complex with a more prominent role played by physician specialists, MRI facilities, laboratories, hospitals, drug companies, skilled nursing facilities, etc. The healthcare industry has become so large, with so many dollars at stake, that consumers are bombarded with advertising and solicitations to use their service or product. The patient is hardly in a position to make an informed decision, while today's primary care physician does not have enough time to see a patient, never-mind assist with sorting through the healthcare maze.

The Consequences—The healthcare system sweeps people up into a virtual conveyor belt of care without the patient being in charge of the process. This process leads to disjointed care exposing the patients to potential medical hazards (medication errors, etc.) and promotes a spiraling system of financial excess driving medical costs higher and higher. Therefore, the legacy system of healthcare is not sustainable. The changes brought forth by consumer driven healthcare will, over time, mimic the competition in other industry sectors.

Additional Factors—The healthcare system is being pushed by other “winds of change” that have not been felt before. These additional factors include:

The Growth of Retail Health Clinics—The shortage of doctors coupled with the ever-increasing demands for after-hours access to the healthcare system has spawned a new cottage industry, “Convenience Care”. Led by CVS® with its MinuteClinics®, this initiative may change the healthcare system permanently by having nurse practitioners deliver care at times and days that are best for the patient.

Increased Push to Upgrade Technology—Other industries embrace technology to operate their businesses better and faster. Healthcare has lagged behind significantly due to the lack of accountability and the fact that in the past healthcare was not viewed as a business. The changes that consumers (patients) are demanding, are putting pressure to upgrade to such technologies as electronic medical records and e-prescribing. These changes cause systemic workflow changes in doctor offices and healthcare facilities, not unlike what other industries have had to undergo to embrace change.

Increased Role of Government—As employers and the public have become more disenchanted with the cost of healthcare, politicians have entered the arena to make political promises that may or may not reflect sound business strategy or logical thinking. This element clouds the already murky waters even more by trying to legislate healthcare “solutions”.

The Worsening Economy—The lackluster economy has caused a reassessment by many consumers about accessing the healthcare system. While we acknowledge the role that high deductibles are playing in shifting the consumer mind set, the economy has caused a shift in many elective procedures and office visits that may only have a very small co-pay amount. Physicians and other providers who have never experienced the rash of cancelled appointments and drop-off in referral business are acknowledging the factual evidence. What the long-term effects of this factor alone will be can only be speculated at this point. What can be acknowledged is that the worsening economy, coupled with other changes in the healthcare landscape, will change the industry profoundly.

How Do We Analyze The Future of Healthcare?—Since antiquity, when Hippocrates wrote “Do no harm”, countless patients have put their trust in the quality of the physicians who have taken that oath. Somewhere along the line, medicine became a business—a $2.3 trillion a year business-run by people who have taken no such oath.

Many people say that the best way to predict the future is to examine the past. In the healthcare industry, the past may be so far removed from current reality that there is no going back. The industry is a complex maze with too many variables that have changed too deeply to resurrect what it was supposed to be all about. There are no more Dr. Marcus Welbys who make house calls and know the entire family by name. There is an insurance payment system that has been tainted by a public who wants the best care at no cost. Back in the 1950's, Blue Cross started as a catastrophic insurance plan in Dallas for hospital coverage at fifty cents a week. It was intended as a finance mechanism for those individuals who could not afford to get slapped with a high hospital bill. All these years later, most employers offer health insurance as a “necessity” to attract and retain top talent. Knowing this, insurance companies over decades have leveraged that employer belief into a financial goldmine, while offering first dollar coverage plans to employees. The employees then demand more and more access and coverage, forcing the employers to buy richer and more expensive insurance programs from the insurance companies. The vicious cycle has continued unchecked for decades. In fact, the dollar growth of the healthcare industry has caused more and more providers to enter the fray. Marcus Welby, M.D. probably didn't know who a specialist was, since he took care of almost everything (including rounding on the patient in the hospital). Now, most doctors only want to be specialists, with earning potentials of high-six figure or low seven figure amounts per year. The days of the past, therefore, in this industry, may not be the predictor of the future. We must turn elsewhere for answers.

Other Industries—Other industry markets respond far differently to the economic supply and demand equation. In many instances, the response is driven by fierce competition. The competition helps keep prices in check and the level and quality of services provided relatively high. By way of example, we can examine the airline and hotel industries. Both industries are driven by competition, with each industry looking for new ways to woo the customer to their brand. Each industry is a direct-to-consumer type service industry, fighting for both the attention and the money of the individual. Each industry has been incredibly successful with loyalty programs, rewarding customers with points in that particular company's reward program. When you speak with a neighbor or friend, you will quickly learn that the individual will only stay at a “Marriott” or “Sheraton” chain hotel, even if it is five or ten miles out of the way, in order to “get their points”.

What the hotel and airlines industries made popular, almost every other retail-oriented industry has now copied. We are a “point” crazed society. If you eat lunch at Subway, you can get points. Care to watch a movie, Regal Cinema will give you points. The retail market craves your attention. Why? It is a simple and easy answer. The consumer is directly paying for the goods and services. This is the major disconnect in the healthcare industry. Until recently, the consumer really wasn't directly paying for their healthcare. The attention, therefore, has historically gone to those who do, namely, insurance companies.

As we turn to other industries for answers, we notice a couple of obstacles. The consumer space is unfamiliar territory for the healthcare industry. Constituents within the healthcare sector have turf to protect, so the hope by many is that this consumerism push will just go away. After all how can you continue to charge twice as much as a competitor and not tell the public?

Another potential obstacle is government legislation. Healthcare providers (physicians) are not allowed to provide consumer (patient) inducements for referrals. They also can't pay a patient to come visit them, even if it is to improve the patient's care and well-being. The challenge is for a patient to be educated to know what physician or provider or facility provides high quality care in a cost-effective manner. The entrenched players in healthcare, those who have thrived in the $2.3 trillion per year business, want no part in changing the status-quo. They have not had to compete for customers attention, or, most of all, money. Simply put, they are not about sharing or re-distributing.

Fast Learners—However tight the grip of control remains on the legacy healthcare system, when patients begin paying $2,000 deductibles with their credit cards, they become fast learners. Nothing will destroy the legacy system faster than the exposure to the sunlight of consumers voting with their feet. Witness the effects, good or bad, on the pharmaceutical industry. For years and years, thousands of pharmaceutical representatives visited doctor offices daily to help persuade them to prescribe their brand of drug. Today, thousands of pharmaceutical reps are being laid off, as consumerism is over-taking that industry. Ads on television are replacing the representatives. The television ads demand that the patient go into the doctor's office and ask for the “XYZ” drug. Note that the ads cannot be targeted by disease state, so the pharmaceutical companies look for the ads to resonate with those with “diabetes”, “heart disease”, etc. (depending on the drug). The consumers have responded to the ads, and pushed, through their voice, the upswing in market share of a certain drug. Yet another example of direct-to-consumer success in marketing, only now healthcare is finally the long overdue target.

The Opportunity—A Brave New World That Demands Quality.—The challenges, obstacles, and the need for change, all create opportunity. The Kaiser Family Foundation Background Brief on U.S. Healthcare Costs cites a number of major areas for containing future healthcare costs. Investment in information technology (IT)—Greater use of technology, such as electronic medical records (EMR), has been promoted and researched for its potential to more efficiently share information and reduce overhead costs. $19 billion in federal funding has already been allocated to uniformly upgrade health IT, a major component of the Obama administration's health reform plan, indicating that the movement to invest in IT has gained significant traction.

Improving quality and efficiency—There are a number of initiatives in play that aim to help make the health care system more efficient and higher quality, and consequently more cost-effective. Overall, decreasing unwarranted variation in medical practice and unnecessary care is seen as a priority, particularly geographic variation, since higher spending on health care in certain geographical areas does not correspond to better health outcomes. Some experts estimate that up to 30% of health care is unnecessary, emphasizing the need to streamline the health system and eliminate this needless spending.

Adjusting provider compensation—The current system of provider compensation pays physicians a given fee per procedure or test, for example, as dictated by the Medicare Physician Fee Schedule guidelines for the value of over 10,000 physician services. Currently, there are proposals to revamp some provider payments to ensure that fees paid to physicians reward value and health outcomes, rather than volume of care. This is meant to eliminate unnecessary care and thereby decrease costs. Comparative effectiveness research (CER) is being increasingly emphasized as a means to determine which treatments are most effective for given conditions, in order to provide doctors with the necessary information to make the best choices for patients' care.

Government regulation—Citing the success of the Medicare program in controlling per capita spending over its history and warning that market-based approaches combined with greater individual financial responsibility can disadvantage those with limited financial resources and create barriers to needed care, some policymakers favor more government involvement in the health care sector. Critics argue that such regulation stifles innovation and that market-based approaches are more cost-effective and will provide consumers with a wider range of choices.

Prevention—The burden of chronic diseases, such as diabetes and cardiovascular disease, has risen dramatically; both of these chronic conditions are known to be correlated with obesity, smoking, and diet, and are very expensive to treat over long periods of time. Proposals have been put forward to emphasize prevention by providing financial incentives to workers to engage in wellness and prevention, in order to decrease the prevalence of these conditions and avoid incurring the long-term costs of treatment. However, it is unclear how much prevention programs will decrease costs, since paradoxically healthier people will likely live and use the health system longer. For those already suffering from chronic diseases, disease management strives to improve and streamline the treatment regimen for common, chronic health conditions.

Increasing consumer involvement in purchasing—Supporters of “consumer-driven” health care believe that greater price transparency would make consumers more price sensitive and more prudent purchasers and thus save consumers and employers money. One of the major forms currently is tax-favored “health reimbursement accounts (HRA),” to which employers contribute funds that are managed by the employee to spend on primary health care as she directs. Critics of the consumer-directed approach raise concerns about the potential impacts that the higher cost-sharing would have on lower income people and about the potential for these new arrangements to be disproportionately used by healthy people, shifting sicker groups to more expensive forms of insurance.

Altering the tax preference for employer-sponsored insurance—Currently, employees do not pay income or payroll tax on money employers spend on their health insurance, regardless of the cost of those benefits. Some current health reform proposals suggest eliminating or changing the tax exclusion for employer-sponsored health care to help finance the costs of expanding coverage as well as reducing incentives for the most generous and therefore expensive health plans. One possibility is that the tax exclusion would be capped at the value of benefits received by Members of Congress, and employees opting for more expensive health plans would be taxed on the difference. Those against eliminating the tax exclusion worry that doing so could drive up the cost of health insurance to workers and disproportionately affect smaller companies and those with an older workforce, who tend to pay higher premiums.

With this emphasis on cost, the patient is not looking to reduce the quality of their healthcare. Again, the industry has struggled with how to define quality care. The truth is that the answer is the same as defining beauty. It resides in the eyes of the beholder. What is known is that any solution for the future must embrace the elements we have defined and empower the consumer to take charge of their destiny.

The Health Care Rewards program—How do you spell “Success”? The Health Care Rewards program uses smart card technology to improve quality by capturing a personal health record on the card. In addition, emergency medical information can be captured, as well as insurance and other personal data.

The smart card technology is used for healthcare in a number of other countries. Taiwan has introduced 24 Million health cards+30,000 medical professional's cards. o France has about 60 Million health cards. Australia and Germany also use healthcare smart-cards extensively.

The smart card is used by the patient when accessing a service from one of the Participating and/or Preferred Providers. The smart card is read by a doctor or other Participating and/or Preferred Provider to better co-ordinate the patient's healthcare. To promote quality, and make it fun for the patient, the patient receives “points” each time they present their smart card for a medically necessary service.

Overview—The overview of the Health Care Rewards program is as follows. Patient rewards program to earn points for use of Participating and/or Preferred Providers. Points can be redeemed by patients by logging on to a special web site, similar to consumer airline and hotel reward point programs.

Why become involved with the Health Care Rewards Program? It aligns the patient with a physician chosen from a list of the Participating and/or Preferred Providers. It is applicable to all patients, both insured and uninsured. There is no cost for the patient to join. Timing of the program is aligned with high deductible, consumer driven healthcare.

Program is unique within healthcare—Promotes high quality, cost-effective healthcare, making this program an easy choice for consumers.

The Unique Design—The uniqueness of the Health Care Rewards program is that it is the first time a healthcare smart-card, containing patient data, has been merged with the power of a rewards program to encourage healthy behaviors and patient wellness. This is also a system that is updated by medical professionals and shared with healthcare providers in the industry when the patient presents their card. Other web-based portals offer personal health records that are updated only by the patients themselves. Since most patients lack medical training, this information could be less accurate than information updated by the medical professional. Further, while many provider offices and sites of service have computers and electronic medical records, most of these providers do not share the information stored in their system with other healthcare professionals. Since the computers don't “talk to each other” the care can be disparate. The consistent information provided by the Health Care Rewards Program smart-card allows for improved care-giving based on data that is stored on the card and shared at the discretion of the patient.

The high level of use of the healthcare smart-card technology in other countries in Europe and Asia is driven by national health systems that mandate its use. There is no reward system for the use of the technology, and therefore, no voluntary patient engagement in the process. The Health Care Rewards Program embraces the smart-card technology while encouraging the use of high quality, cost-effective providers for necessary medical care. By awarding points for positive healthcare behaviors, the patients are improving the quality of their own healthcare (patient empowerment) and saving both themselves and the entire healthcare system money at the same time. The Health Care Rewards Program offers reward points not only to improve patient care, but to also encourage patient adoption and use of the software technology. Greater adoption of the Health Care Rewards Program software means more business growth for everyone involved in the program. The unique design features of this program allow all parties involved to become “winners” on a multitude of levels. This design merges concepts from other industries to bring together for the first time a unique and effective system to assist patients in choosing quality, cost-effective health care at a time when they are being thrust into making more of their own decisions as a result of higher costs and high-deductible health plans offered by the insurance companies around the country.

Security—The security aspects of the program are both important and significant. The fundamental idea behind HIPAA, the Health Insurance Portability and Accountability Act, is to increase patient control of the dissemination of their healthcare information. It is important to remember that the patient controls their data, since they hold the healthcare smart-card. If they do not want anyone to see their personal health record, they can choose to not hand the card to the provider.

The technology itself provides a high level of patient data security. First, it is a two card system. Second, it is a two reader system. A “Provider Authorization Card” must be placed into a designated card reader to be ready to accept a “Patient Card”. The “Patient Card” is then placed into a second designated card reader. Both designated card readers are connected to a personal computer (in some cases directly in the physician exam room). The personal computer is set up with a software program that authenticates that the two authorization smart-cards are in the designated card readers. This becomes the third level of security. The fourth level takes place when the programs goes out over the internet to the Health Care Rewards Program website and verifies that the other three levels of security (Provider Authorization Card, Patient Card, Authentication Program software) have been met. Only when all these security steps have been met will the program allow the card to be read and shown on the provider's screen. If any of the steps are incomplete or missing, it will not read or display the data on the healthcare smart-card. This protects the patient, so if the card is lost or stolen, no one can distinguish the card from a blank one (except an authorized provider who has been set up by Health Care Rewards Program). Additionally there is no patient name printed on the outside of the card itself.

Market Timing/Universal Appeal—The timing of the Health Care Rewards Program corresponds to the national drive to consumer driven healthcare, capitalizing on the surge to high deductible insurance plans where most of the initial payments of up to $2,000 or more are now a patient's responsibility. This market change has caused patients to need to become much more educated about the cost and quality of healthcare. Healthcare costs have, until recently, been a total mystery to the patient because claims have been paid directly by the insurance company. The paradigm shift has caused patients to become “consumers of healthcare” by making value decisions and engaging them in the entire process of decision-making.

At the state and federal levels there is an appetite for healthcare accountability. The Centers for Medicare and Medicaid Services (CMS) have begun the process of developing Accountable Care Organizations (ACOs) in an effort to promote quality and affordability. “Risk contracting”, as it is known, is a way to bring the provider and patient closer together in the healthcare decision process. CMS has also actively promoted “patient engagement” to help prevent patients from being forced into healthcare decisions that they may not want or agree with. The Health Care Rewards Program embraces the elements put forth by CMS. It brings the provider and patient closer together in the healthcare decision process by sharing consistent data stored on the card. Further, it empowers the patient to be more involved in their own healthcare decisions, since they control who sees the card and how that information is used to improve the quality of their care. The Health Care Rewards smart-card program is also universal. It is open to everyone, insured or not, regardless of medical condition. It is not insurance, and has nothing to do with insurance payors. It is web-driven and can be adopted in any part of the country, so is easily transferable to engage patients and providers in any geography.

The Health Care Rewards Program is technology innovation that promotes patient engagement, improving the quality of care.

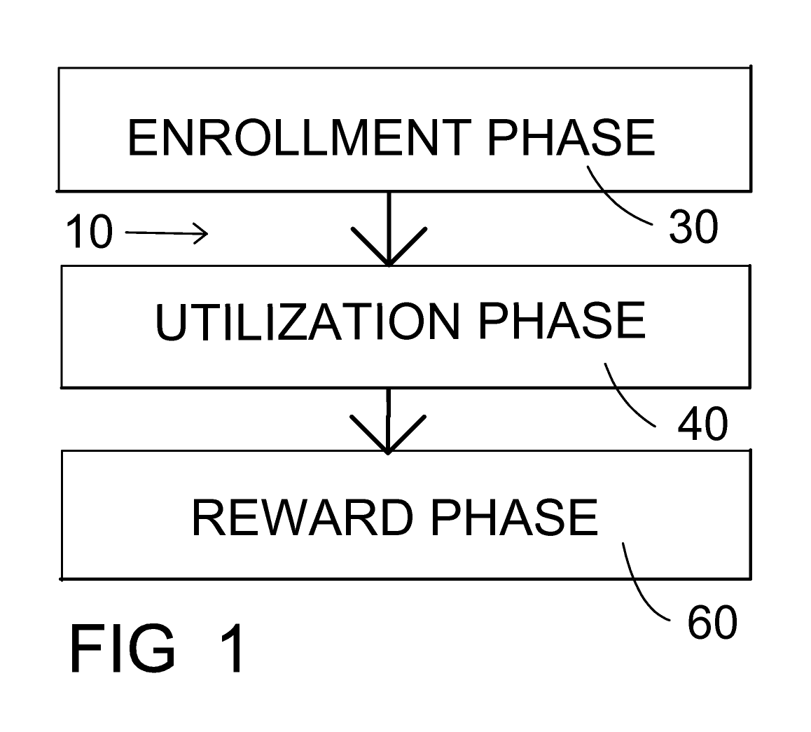

Referring to FIG. 1, in the preferred embodiment of the Health Care Rewards Program 10, there are three phases. First is the enrollment phase 30. Second is the utilization phase 40. Third is the reward phase 60.

THE ENROLLMENT PHASE: In the enrollment phase 30, the patient 11 contacts the program enrollment agent 12 and submits an application 31 to the program 10. In one embodiment of this invention, the enrollment agent 12 would be one of the qualified health-care providers 14, in another embodiment, the enrollment agent 12 may be a company representative 20, and in another embodiment, the enrollment agent would be a centralized online facility 15 that would allow the patient to enroll online.

The result of the enrollment activity would be the issuance to the patient 11 of a program device 13 which, in the preferred embodiment of this invention, would be a smart card 16, that is, a credit-card-type device that includes a substantial digital memory that is capable of being read from and written to. This might be a device that requires contact with a reader-writer, or it might be a device that can communicate with the reader-writer without physical contact. Typically this non-contact device uses a radio frequency signal. The device could also be incorporated into a smart-phone or other computer-like device such as a tablet or laptop computer. The enrollment phase 30 would include the patient's 11 enrollment in a central computer network 17.

This enrollment phase 30 also includes the initial writing of the patient's personal health record 18 to the program device 13, using a data format universal to participants in the program 10. In the preferred embodiment of this invention, the patient would visit a qualified healthcare provider 14 who would have the capability of acquiring the patient's medical records 18 and writing some or all of those records 18 to the program device 13.

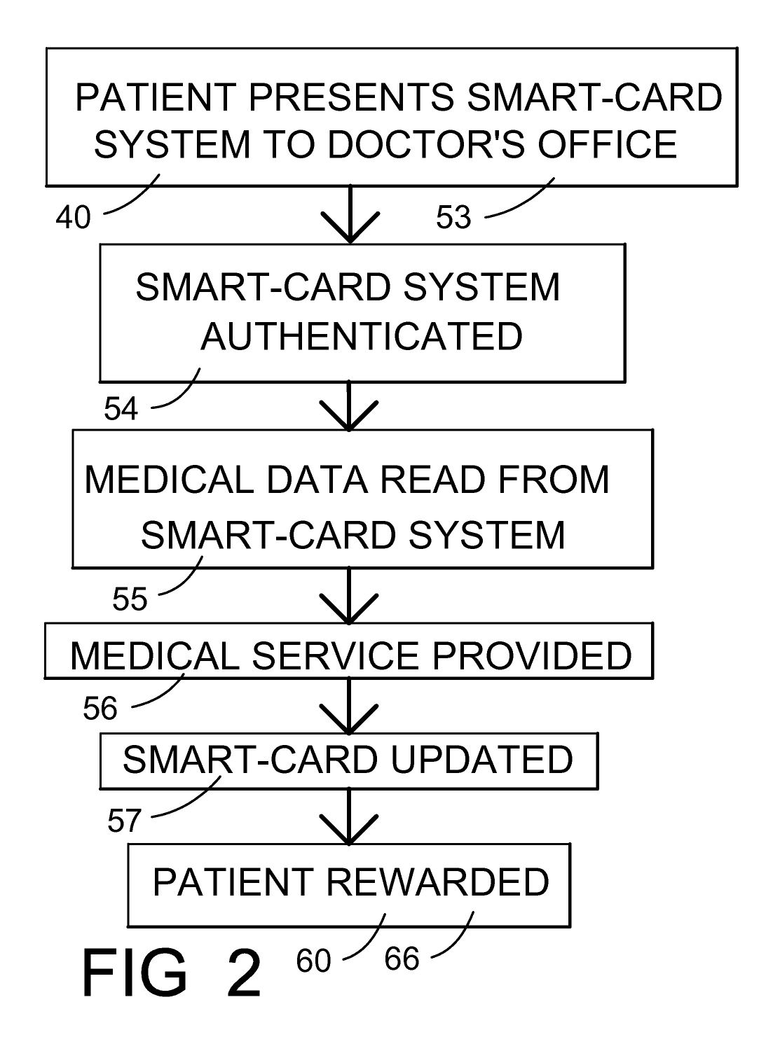

The enrollment phase 30 will normally occur only once, but the utilization phase 40 and the reward phase 60, as shown in FIG. 2, will occur over and over again. As shown in FIG. 2, the utilization phase 40 has a number of steps. The patient presents the smart card system to the doctors office 53. The smart card is authenticated 54. Medical data is read from the smartcard system 55. Medical services are provided 56. The smartcard is updated 57. Then the reward phase 60 occurs in which the patient is rewarded 66.

THE UTILIZATION PHASE: Once the patient has the program device 13 and it contains the patient's personal health records 18, the patient must go to a directory 19 of qualified participating providers 14 to select a health related provider 14 that the patient 11 wishes to engage. The patient 11 makes an appointment or other arrangement and visits the selected qualified participating provider 14. The patient offers the qualified participating provider the program device 13 and the participating provider employs a program device reader 42 to read the contents of the program device 13. The participating provider also employs a credential device 43. In a preferred embodiment, the credential device 43 is a credential reader 44 that reads a credential indicator 45, such as a smart card, and thereby indicates that the participating provider is authorized to read the program device 13. The device reader 42 and the credential device 43 operate through a coordinating device 46 that is adapted to determine whether the credential reader proves that the participating provider 14 is authorized to read the program device 13. In the preferred embodiment of this invention, the coordinating device 46 is also adapted to establish a remote electronic communication link 47 with an online central authenticator 48 that provides additional security that the participating provider 14 is in fact authorized to read the program device 13. In the preferred embodiment of the invention, the online central authenticator 48 is part of the central computer network 17.

For example, if the credential device 46 is stolen, the fact would be reported to the online central authenticator 48 that would then refuse to allow the program device 13 to be read by someone who had possession of a stolen credential device 46.

Once the personal health record 18 on to the program device 13 is accessible to the participating provider 14, the participating provider 14 can glean information, which may be used to treat the patient 11 and can update the personal health record 18 as a result of that treatment.

In addition, the qualified health-care provider 14 or the program 10 awards the patient certain reward points 49 in acknowledgment that the patient has selected an authorized and qualified participating provider 14 who accepts and uses the program's 10 program device 13.

In one embodiment of this invention, the reward points 49 are recorded on the program device 13. In another embodiment of the invention, the reward points are transmitted electronically to a remote reward points record keeping device 51, which, in the preferred embodiment, is associated with the central computer network 17. In the preferred embodiment of this invention, both of these communications are performed.

THE REWARD PHASE: In the reward phase, the patient is able to expend the accumulated reward points 49 to obtain benefits 61, such as goods 62. In the preferred embodiment of this invention, this is accomplished by providing the patient 11 with online access to the remote reward points record keeping device 51 to check up on how many reward points the patient 11 has accumulated. The patient 11 also has online access to an online reward points redemption device 63 that may be the same as the remote reward points record keeping device 51 or different. The reward points redemption device 63 is adapted to present the patient 11 with various benefits 61, such as goods 62, that are available to the patient 11 in exchange for some or all of the reward points 49. The redemption device 63 is adapted to provide the patient 11 with the ability to make a selection among those benefits 61, such as goods 62, is adapted to arrange for providing the selected benefits 61, such as goods 62, to the patient 11, and is adapted to adjust the records concerning the accumulated reward points 49 that the patient 11 owns.

In the preferred embodiments the reward points record keeping device 51 would make appropriate adjustments in its records to reflect the reward points redemption transaction 64, and would be adapted so that the next time that the patient uses the program device 13 at an authorized healthcare provider 14, the reward points record 65 on the program device 13 would be appropriately adjusted. In the preferred embodiment of this invention, the reward points record keeping device 51 would be part of the central computer network. Furthermore, for security purposes, the reward points record keeping device 51 would have separate access requirements, then the areas of the central computer network 17 organized to keep track of the association between the rewards points 49, the health-care providers 14, and patients 11.

SECURITY: One of the aspects of this invention involves security of the related information including the identity of the participating provider who awards the reward points. For numerous reasons, particularly with regard to management of the overall program, it is essential that the identity of the participating provider who awarded certain specific reward points be maintained. If that specific information were accessible to unauthorized parties, it could violate the privacy rights of the patient and, could cause significant psychological and other injury to the patient. Clearly, the patient would not wish the public to know that the patient was seeking care from a provider that specialized in certain ailments or certain procedures. As a result, it is essential that the information relating to the healthcare provider who awards a reward points is treated with extreme security.

Thus, the system of the present invention is designed so that access to the identity of the participating provider that processed the reward points to a particular patient is subject to extreme security which may require a relatively burdensome access procedure.

ACCESS: On the other hand, the rewards points system itself and the information about the accumulation of reward points for a particular patient must be highly accessible to the patient, in order to make the reward points redemption process efficient, effective, and pleasant for the patient. In order for the patient to manage and enjoy the reward points, it is essential that the patient be able to very easily get access to the amount of their accumulated reward points. This will enhance the redemption experience and allow the program to be attractive to the patient. Thus, the system of the present invention is designed so that access to the number of accumulated reward points owned by a particular patient is relatively easy while maintaining the very high security concerning the healthcare provider that processed the points to the patient.

BENEFITS: To the patient, this invention provides the short-term benefits of the goods and services which the patient receives by redeeming the reward points. However, in the long run, because the patient is encouraged to seek treatment from high-quality, cost-effective participating providers, the patient is able to lead a healthier, more cost-effective, and therefore happier life.

To the participating provider, the system provides an effective and very attractive marketing capability not only because the healthcare participating provider is listed in the marketing materials created by the invention, but also because inclusion in this system is essentially an endorsement that the participating provider is of high quality and is cost effective.

To our society in general, the system provides a highly consumer accepted means by which the providing of healthcare can be encouraged to be of high quality and also highly cost effective. Thus, the system provides one tool useful in the goal of developing a national health care delivery system that satisfies our national expectations and is sustainable for the long term.

It is obvious that minor changes may be made in the form and construction of the invention without departing from the material spirit thereof. It is not, however, desired to confine the invention to the exact form herein shown and described, but it is desired to include all such as properly come within the scope claimed.

1. A system for operating a Health Care Rewards Program for a patient, comprising:
a. a program enrollment agent, adapted to enroll the patient in the healthcare rewards program,
b. a program device that is provided to the patient and includes a digital memory that is capable of being read from and written to,
c. a patient's personal health record that is written to the digital memory in the patient's program device,
d. a plurality of qualified participating providers, who are members of the health care rewards program, and adapted to provide the patient with healthcare,
e. a credential device issued to each qualified participating provider, and adapted to indicate that the qualified participating provider is a member of the health care rewards program,
f. a program device reader, adapted to read the patient's personal health care record from the digital memory of the patient's program device when allowed by the credential device,
g. a reward points issuance facility, adapted to allow the qualified participating provider to process reward points to the patient,
h. a reward points memory which accounts for the granting and the use of the reward points involved in the health care rewards program, and
i. a rewards point redemption center, adapted to allow the patient to exchange reward points for goods or services.

2. A system as recited in claim 1, wherein the enrollment agent is one of the qualified health-care providers,

3. A system as recited in claim 1, wherein the enrollment agent is a company representative,

4. A system as recited in claim 1, wherein the enrollment agent is a centralized online facility that would allow the patient to enroll online.

5. A system as recited in claim 1, wherein program device is a smart card, that is, a credit-card-type device that includes a substantial digital memory that is capable of being read from and written to.

6. A system as recited in claim 1, wherein the program device requires contact with a reader-writer,

7. A system as recited in claim 1, wherein the program device can communicate with the reader-writer without physical contact.

8. A system as recited in claim 1, wherein the program device uses a radio frequency signal communicate with the reader-writer without physical contact.

9. A system as recited in claim 1, wherein the program device is incorporated into a smart-phone or other computer-like device such as a tablet or laptop computer.

10. A system as recited in claim 1, wherein the patient would visit a qualified healthcare provider who would have the capability of acquiring the patient's medical records and writing some or all of those records to the program device.

11. A system as recited in claim 1, wherein the patient must go to a directory of qualified participating providers to select a health related provider that the patient wishes to engage.

12. A system as recited in claim 1, wherein the patient makes an appointment or other arrangement and visits the selected qualified participating provider.

13. A system as recited in claim 1, wherein the patient offers the qualified participating provider the program device and the participating provider employs a program device reader to read the contents of the program device.

14. A system as recited in claim 1, wherein the participating provider also employs a credential device.

15. A system as recited in claim 1, wherein the credential device is a credential reader that reads a credential indicator, such as a smart card, and thereby indicates that the participating provider is authorized to read the program device.

16. A system as recited in claim 1, wherein The device reader and the credential device operate through a coordinating device that is adapted to determine whether the credential reader proves that the participating provider is authorized to read the program device.

17. A system as recited in claim 1, wherein the coordinating device is also adapted to establish a remote electronic communication link with an online central authenticator that provides additional security that the participating provider is in fact authorized to read the program device.

18. A system as recited in claim 1, wherein if the credential device is stolen, the fact would be reported to the online central authenticator that would then refuse to allow the program device to be read by someone who had possession of a stolen credential device.

19. A system as recited in claim 1, wherein once the personal health record on the program device is accessible to the participating provider, the participating provider can glean information, which may be used to treat the patient and can update the personal health record as a result of that treatment.

20. A system as recited in claim 1, wherein the company awards the patient certain reward points in acknowledgment that the patient has selected an authorized and qualified participating provider who accepts and uses the company's program device.

21. A system as recited in claim 1, wherein the reward points are recorded on the program device.

22. A system as recited in claim 1, wherein the reward points are transmitted electronically to a remote reward points record keeping device.

23. A system as recited in claim 1, wherein the reward points are both recorded on the program device, and transmitted electronically to a remote reward points record keeping device.

24. A system as recited in claim 1, wherein the patient is able to expend the accumulated reward points to obtain goods or other benefits.

25. A system as recited in claim 1, wherein the patient with online access to the remote reward points record keeping device to check up on how many reward points the patient has accumulated.

26. A system as recited in claim 1, wherein the patient has online access to an online reward points redemption device that may be the same as the remote reward points record keeping device or different.

27. A system as recited in claim 1, wherein the reward points redemption device is adapted to present the patient with various goods or other benefits that are available to the patient in exchange for the reward points.

28. A system as recited in claim 1, wherein the redemption device is adapted to provide the patient with the ability to make a selection among those goods or other benefits, is adapted to arrange for providing the selected goods and other benefits to the patient, and is adapted to adjust the records concerning the accumulated reward points that the patient owns.

29. A system as recited in claim 1, wherein the reward points record keeping device would make appropriate adjustments in its records to reflect the reward points redemption transaction, and would be adapted so that the next time that the patient uses the program device at an authorized healthcare provider, the reward points record on the program device would be appropriately adjusted.

30. A system as recited in claim 1, wherein the system is designed so that access to the number of accumulated reward points owned by a particular patient is relatively easy while maintaining the very high security concerning the healthcare provider that awarded the points to the patient.

31. A Health Care Rewards Program, comprising:
a.) AN ENROLLMENT PHASE in which:
i.) a patient conducts an enrollment activity, in which the patient contacts a program enrollment agent and submits an application to the program,
ii.) As a result of the enrollment activity, the patient is issued a program device that includes a substantial digital memory that is capable of being read from and written to,
iii.) the enrollment phase includes the initial writing of the patient's personal health record to memory of the program device, using a data format universal to participants in the program,
b.) A UTILIZATION PHASE in which:
i.) the patient visits a selected qualified participating provider,
ii.) the patient offers the qualified participating provider the program device
iii.) The participating provider employs a program device reader and a necessary credential device, to read the contents of the program device, the device reader and the credential device operate through a coordinating device that is adapted to determine whether the credential reader proves that the participating provider is authorized to read the program device,
iv.) Once the personal health record on the program device is accessible to the participating provider, the participating provider can glean information, which may be used to treat the patient and can update the personal health record as a result of that treatment,
v.), in addition, the program awards the patient certain reward points in acknowledgment that the patient has selected an authorized and qualified participating provider who accepts and uses the company's program device, and
c.) A REWARD PHASE, in which the patient is able to expend the accumulated reward points to obtain benefits.

32. A Health Care Rewards Program as recited in claim 31, wherein the enrollment agent would be one of the qualified health-care providers.

33. A Health Care Rewards Program as recited in claim 31, wherein the enrollment agent is a company representative.

34. A Health Care Rewards Program as recited in claim 31, wherein the enrollment agent would be a centralized online facility that would allow the patient to enroll online.

35. A Health Care Rewards Program as recited in claim 31, wherein the program device would be a smart card, that is, a credit-card-type device that includes a substantial digital memory that is capable of being read from and written to.

36. A Health Care Rewards Program as recited in claim 31, wherein the program device is a device that can communicate with the reader-writer without physical contact.

37. A Health Care Rewards Program as recited in claim 31, wherein the patient would visit a qualified healthcare provider who would have the capability of acquiring the patient's medical records and writing some or all of those records to the program device.

38. A Health Care Rewards Program as recited in claim 31, wherein the coordinating device is also adapted to establish a remote electronic communication link with an online central authenticator that provides additional security that the participating provider is in fact authorized to read the program device.

39. A Health Care Rewards Program as recited in claim 31, wherein the reward points are recorded on the program device.

40. A Health Care Rewards Program as recited in claim 31, wherein the reward points are transmitted electronically to a remote reward points record keeping device.

41. A Health Care Rewards Program as recited in claim 31, wherein the reward points are recorded on the program device, and the reward points are transmitted electronically to a remote reward points record keeping device.

42. A Health Care Rewards Program as recited in claim 31, wherein access to the identity of the participating provider that processed the reward points to a particular patient is subject to extreme security which requires a relatively burdensome access procedure, but the patients access the accumulation of reward points is relatively easier.
